(19) United States
(12) Patent Application Publication
(10) Pub. No.: US 2009/0009806 A1
(43) Pub. Date: Jan. 8, 2009

(54) Image processing apparatus

(76) Inventor: Masazo Matsuda, Osaka (JP)

Correspondence Address: JORDAN AND HAMBURG LLP, 122 EAST 42ND STREET, SUITE 4000, NEW YORK, NY, 10168, US

(21) Appl. No.: 12/214,958

(22) Filed: Jun. 24, 2008

(30) Foreign Application Priority Data
Jun. 26, 2007 (JP) 2007-167995

(51) Int. Cl. G06F 3/12

(52) U.S. Cl. 358/1.15

(57) ABSTRACT

An image processing apparatus is provided to perform setting of setup item(s) assigned to shortcut key(s) as easily as possible.

When a setup item assigned to a flexible key 132 is an alternative setup item set to a setup content selected from among a plurality of setup contents, the setup content is set by displaying the plurality of setup contents one by one in sequence in a display area 132a according to the operation of the flexible key 132 (FIGS. 5 (a), (f) and (e)). On the other hand, when a setup item assigned to a flexible key 131 is an operation input setup item set to setup content by operation inputting by using the operation input keys, the setup content is set by displaying an operation input screen for operation inputting by using the operation input keys in accordance with the operation of the flexible key 131 (FIG. 5 (b)).

### BACKGROUND OF THE INVENTION

1. Field of the Invention

The present invention relates to an image processing apparatus, such as a copier, a printer, a facsimile and a scanner, and more specifically, to the improvement of operational ease when various setup items concerning the image processing apparatus are to be set.

2. Description of the Related Art

An image processing apparatus, such as a copier, a printer, a facsimile and a scanner, is generally provided with a liquid crystal display for displaying various setup items concerning the image processing apparatus (magnification, the color of image, etc.), operation keys for setting these setup items (a numeric keypad, an arrow key, an enter key, etc.), and the like. In the image processing apparatus, these setup items are represented in a hierarchical structure (tree structure). Therefore it is necessary for a user to find a desired setup item in the tree structure by operating operation keys and cause it to be displayed in the liquid crystal display, but it is troublesome to perform such sequences each and every time.

Thus, a shortcut key function has been conventionally used, which allows setup items of the most frequent use to be displayed by the operation of only shortcut keys to which these setup items have been pre-registered (e.g. refer to Patent literature 1: Japanese Unexamined Patent Application Publication No. 2000-305701). As a result, it eliminates the need for looking for setup items of the most frequent use each and every time, and improves the operational ease when these setup items are to be set. Now, with the reference to FIG. 6, the conventional way of transition of setup screens by using the aforementioned shortcut function will be described. FIG. 6 is an explanatory diagram showing the transition of setup screens in the conventional way, in which parts similar to those of a Multi Functional Peripheral associated with the embodiment of the present invention to be described hereinafter (an example of image processing apparatuses) are denoted with the same reference numerals.

As shown in FIG. 6 (a), flexible keys 131 and 132 are located on the lower side of a liquid display 11. The flexible keys 131 and 132 have different roles respectively depending on the screen display of the liquid display 11. Here, the flexible keys 131 and 132 are used as the aforementioned shortcut keys. The flexible keys 131 and 132 are previously assigned to the setup items of magnification and the color of image respectively.

It is displayed in a display area 131a above the flexible key 131 that the flexible key 131 corresponds to the setup item of magnification (Zoom) with the setup content thereof (100%). Meanwhile, it is displayed in a display area 132a above the flexible key 132 that the flexible key 132 corresponds to the setup item of the color of image (Color) with the setup content thereof (Full).

Firstly, in the state of FIG. 6 (a), when the flexible key 131 is operated by the user, the display screen of liquid crystal display 11 is transited to FIG. 6 (b). FIG. 6 (b) shows a list of setup items located at the lower layer of setup item of magnification.

Here, when any one of setup items is selected by the user operating operation keys, the display screen of liquid crystal display 11 is transited to that of setup contents located at a further lower layer as shown in FIG. 6 (c). Specifically, when an operation is performed by the user to select a standard magnification (Standard Zoom) on the display screen of FIG. 6 (b), a list of standard magnification setting values is displayed as shown in FIG. 6 (c). Further, when an operation is performed by the user to select an arbitrary magnification (Zoom Entry) on the display screen of FIG. 6 (b), the display screen is transited to an input screen for inputting an arbitrary magnification by the user operating operation keys.

Subsequently, when a desired magnification is selected from the magnification setting values displayed in FIG. 6 (c) and the selection is completed by the user operating operation keys, the display screen is transited to the display screen of FIG. 6 (e) after the screen showing the setting has been completed as shown in FIG. 6 (d). For example, if 200% is selected on the display screen of FIG. 6 (c) and the selection is completed, it is displayed as it is in the display area 131a for magnification as shown in FIG. 6 (e).

As described above, in setting magnification, the user has to not only operate the flexible key 131 but also perform operation input by using operation keys for moving to the lower layer of setup items, inputting setting values, and the like.

On the other hand, in the state of FIG. 6 (a), when the flexible key 132 is operated by the user, the display screen of liquid crystal display 11 is transited to FIG. 6 (f). In FIG. 6 (f), a list of setup contents associated with the setup item of color of image is displayed. For example, “Full Color”, “Grayscale” and “Monochrome” are displayed as setup contents as shown in FIG. 6 (f).

Subsequently, when a desired setup content is selected from the setup contents of the color of image displayed in FIG. 6 (f) and the selection is completed by the user operating operation keys, the display screen is transited to the display screen of FIG. 6 (e) after the screen showing the setting has been completed in FIG. 6 (d). For example, if “Grayscale” is selected on the display screen of FIG. 6 (f), it is displayed as it is in the display area of 132a for the color of image as shown in FIG. 6 (e).

As described above, concerning the setting of the color of image, it is made by choosing one of three alternatives of setup contents. For example, therefore, it would be also possible to set the color of image on the display screen of FIG. 6 (a) without transiting to the display screen of FIG. 6 (f). Specifically, it would be possible to set the color of image by switching (toggling) only the display of the color of image in the display area 132a in sequence each and every time when operating the flexible key 132 on the display screen of FIG. 6 (a). In this case, the user can easily set the color of image by only operating the flexible key 132 one or more times without operating operation keys.

However, the user has been conventionally required to perform operation input by using operation keys regardless of whether the setup items assigned to the flexible keys 131 and 132 are magnification or the color of image as described above. More particularly, even when a setting is made by alternatively selecting any one from among a plurality of setup contents just like the color of image is selected, it has been necessary for the user to make selection or determination by using operation keys as well as the flexible keys 131 and 132.

Thus, the present invention was devised in consideration of the aforementioned problems, and an object thereof is to provide an image processing apparatus which allows the user to perform the setting operation of setup items assigned to shortcut keys as easily as possible.

### SUMMARY OF THE INVENTION

The present invention to attain the aforementioned object is applicable to an image processing apparatus which is provided with a setup display means for displaying various setup items concerning the image processing apparatus, an operation means having operation input keys for operation inputting to set the various setup items and one or more shortcut keys, and a shortcut key registration processing means for assigning any one of the setup items to the shortcut key or the respective shortcut keys, and constructed as below.

When the setup item(s) assigned to the shortcut key(s) by the shortcut key registration processing means is/are an alternative setup item(s) set to one setup content selected from among a plurality of setup contents, according to the operation of the shortcut key(s), an operation display control means displays the plurality of setup contents one by one in sequence in a display area(s) of the alternative setup item(s) displayed in the setup display means. Meanwhile, when the setup item(s) assigned to the shortcut key(s) by the shortcut key registration processing means is/are an operation input setup item(s) set to setup contents by operation inputting by using the operation input key(s), according to the operation of the shortcut key(s), the operation display control means displays an operation input screen(s) in the setup display means for operation inputting by using the operation input keys. Then, the setup item(s) is/are set to a setup content(s) which is/are displayed by the operation display control means, or to a setup content(s) which is/are set by operation inputting by using the operation input keys in accordance with the operation input screen(s) displayed by the operation display control means.

According to the present invention thus constructed, when the setup item(s) assigned to the shortcut key(s) is/are the alternative setup item(s), a user can easily set the setup item(s) by operating only the shortcut key(s) once or more times. It is unnecessary for the user to operate the operation input keys so that the operational ease is increased when the setup item(s) is/are to be set. Further, when the setup item(s) assigned to the shortcut key(s) is/are the operation input setup item(s), it is possible for the user to set the setup item(s) by the operation input keys according to the operation input screen(s) for setting the operation input setup item(s) as in the past.

Furthermore, the present invention may be embodied in such a way that the image processing apparatus is provided with a setup item classification information memory means for memorizing setup item classification information indicating which each of the various setup items is, the alternative setup item or the operation input setup item, and it is judged which the setup item(s) assigned to the shortcut key(s) is/are, the alternative setup item(s) or the operation input setup item(s), based on the setup item classification information memorized in the setup item classification information memory means.

Specifically, it's conceivable that the alternative setup item(s) and the operation input setup item(s) are displayed in an initial screen of the setup display means. In this case, when the shortcut key(s) corresponding to the alternative setup item(s) is/are operated on the initial screen of the setup display means, every and each time of the operation, the operation display control means switches only setup contents from one to another in the display area of the alternative setup item(s). When the shortcut key(s) corresponding to the operation input setup item(s) is/are operated, the operation display control means changes the initial screen to the operation input screen.

For example, the image processing apparatus may be an image forming apparatus which further comprises a scanner unit for reading image data on a sheet of manuscript and an image forming unit for forming images based on the image data. Furthermore, it would be possible that the image processing apparatus is a facsimile which further comprises a facsimile communication unit for transmitting and receiving image data.

According to the present invention, when the setup item(s) assigned to the shortcut key(s) is/are the alternative setup item(s), the user can easily set the setup item(s) by operating only the shortcut key(s) once or more times, and it is unnecessary for the user to operate the operation input keys so that the operational ease is increased thereby when setup item(s) is/are set. Further, when the setup item(s) assigned to the shortcut key(s) is/are the operation input setup item(s), it is possible for the user to set the setup item(s) by the operation input keys in accordance with the operation input screen(s) for setting the operation input setup item(s) as in the past.

### BRIEF DESCRIPTION OF THE DRAWINGS

FIG. 1 is a block diagram schematically illustrating a configuration of a Multi Function Peripheral according to the embodiment of the present invention;

FIG. 2 is a pattern diagram of an operation display unit arranged for the Multi Function Peripheral according to the embodiment of the present invention;

FIG. 3 is a schematic view useful in illustrating an example of display of the operation display unit arranged for the Multi Function Peripheral according to the embodiment of the present invention;

FIG. 4 is a flow chart useful in explaining an example of the procedure of copy processing executed in the Multi Function Peripheral according to the embodiment of the present invention;

FIG. 5 is a schematic view useful in explaining an example of screen transition in the procedure of copy processing executed in the Multi Function Peripheral according to the embodiment of the present invention;

FIG. 6 is a schematic view useful in explaining the conventional way of setup screen transition.

### DETAILED DESCRIPTION OF PREFERRED EMBODIMENTS

The embodiment of the present invention will be described as referring to the accompanying drawings for the understanding of the present invention. However, the embodiment is intended to illustrate the present invention and is not construed to limit the technical scope of the present invention.

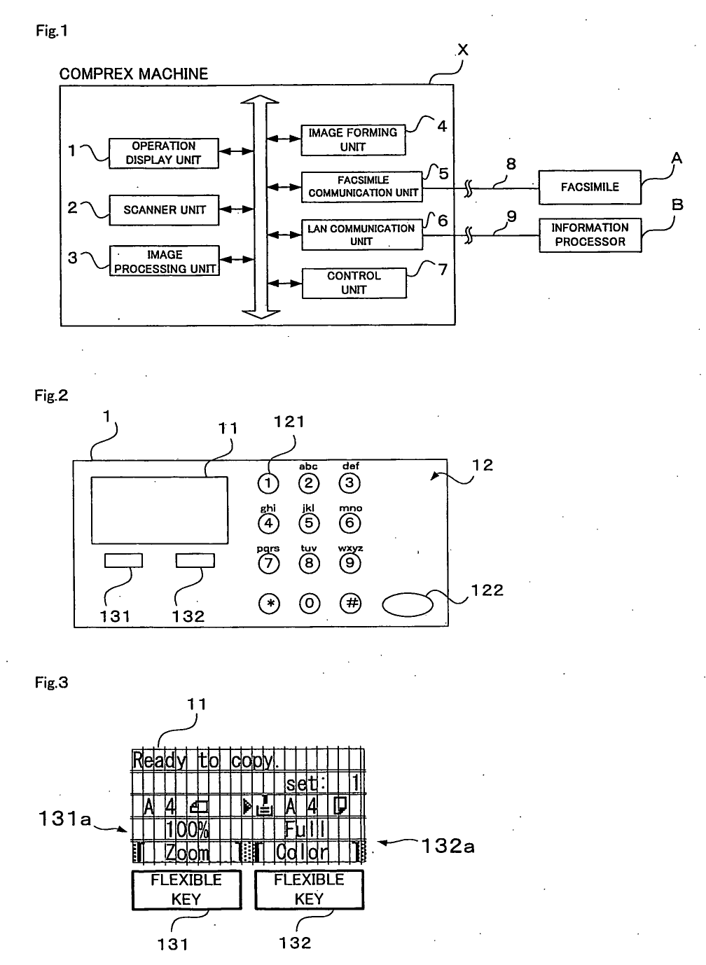

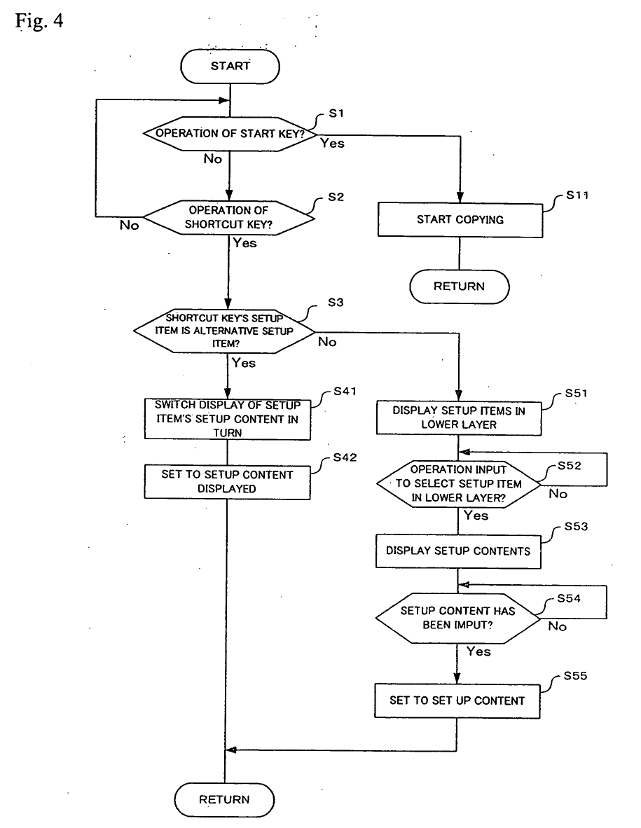

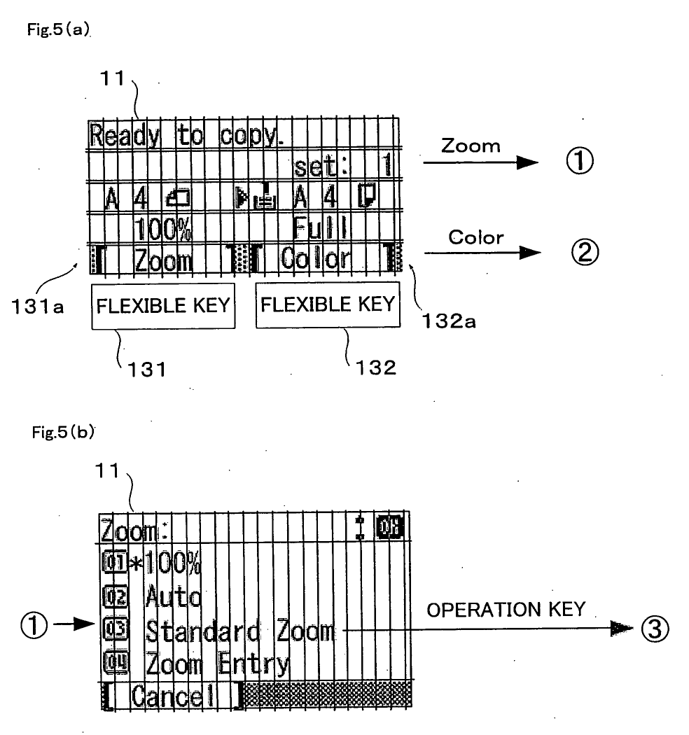

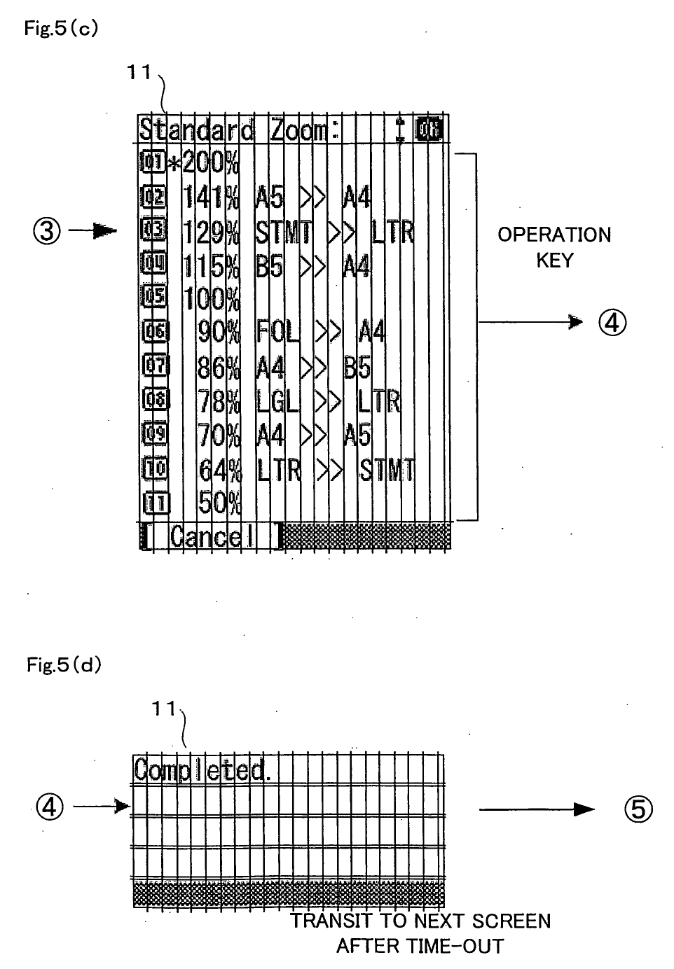

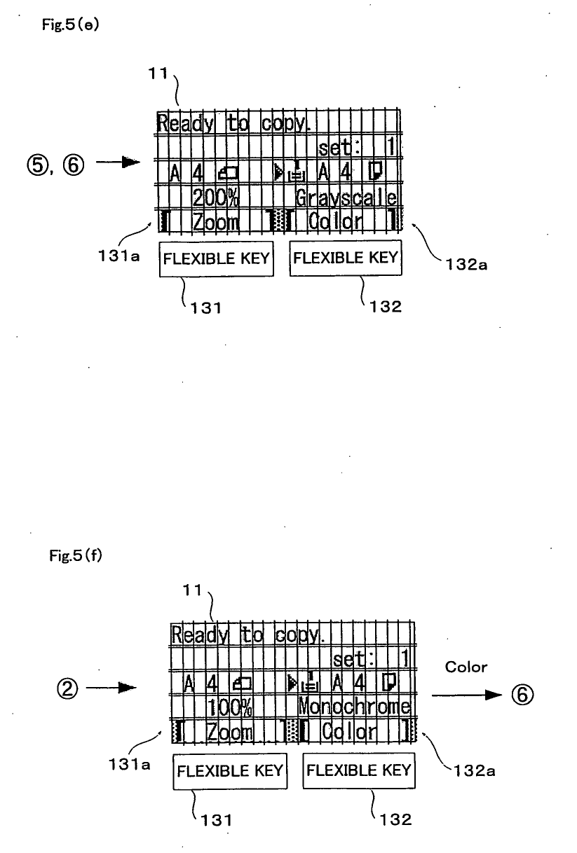

Here, FIG. 1 is a block diagram schematically illustrating a configuration of a Multi Function Peripheral according to the embodiment of the present invention, FIG. 2 is a pattern diagram of an operation display unit 1 arranged for the Multi Function Peripheral, FIG. 3 is a schematic view showing an example of the display on a liquid crystal display 11 of the operation display unit 1, FIG. 4 is a flow chart explaining an example of the procedure of copy processing executed in the Multi Function Peripheral, and FIG. 5 is a schematic view explaining an example of screen transition in the copy processing.

Firstly, the schematic configuration of the Multi Function Peripheral according to the embodiment of the present invention will be described with reference to FIG. 1. The Multi Function Peripheral is only an example of image processing apparatuses according to the embodiment of the present invention, and the present invention is applicable to various image processing apparatuses, such as image forming apparatuses including a copier, a printer and a facsimile, and image reading apparatuses including a scanner.

As shown in a block diagram of FIG. 1, the Multi Function Peripheral is schematically comprised of an operation display unit 1, a scanner unit 2, an image processing unit 3, an image forming unit 4, a facsimile communication unit 5, a LAN communication unit 6 and a control unit 7. Furthermore, the Multi Function Peripheral is connected to a facsimile A through a phone line 8, and an processing equipment B, such as a personal computer, through a LAN 9.

The facsimile communication unit 5 receives image data transmitted from the facsimile A through the phone line 8, or performs a processing for transmitting image data to the facsimile A. A modem is a typical example thereof.

The LAN communication unit 6 is comprised of wire or wireless communication media, equipment and the like in compliance with standards including IEEE802.3 standards and IEEE802.11b, and enables communication with the processing equipment B through the LAN 9.

The scanner unit 2 provided with an image sensor, such as CCD (Charge Coupled Device) and CIS (Contact Image Sensor), reads every line of the image information of a sheet of manuscript set on a platen by scanning the manuscript and stores the information as electronic data.

The image processing unit 3 executes predetermined image processing (compression processing, concentration correction processing, etc.) for image data which have been read by the scanner unit 2, or those received from the facsimile A or the processing equipment B.

The image forming unit 4 is designed to transcribe and fix on a piece of recording paper a visible image (e.g. a toner image) based on image data treated with predetermined image processing by the image processing unit 3, and is comprised of various known devices including a photoreceptor drum, a charging device for charging the surface of the photoreceptor drum at a prescribed electric potential uniformly, a laser scanning unit (LSU) for forming a static electricity latent image by exposure-scanning the surface of the photoreceptor drum, a developing device for developing the static electricity latent image with toner transferred thereto, a transcription device for transcribing the toner image developed on a piece of recording paper, and a fixing device for fixing the toner image transcribed on a piece of recording paper.

The control unit 7 comprising a CPU and other peripheral devices (ROM, RAM, etc.) is designed to control the Multi Function Peripheral totally, and carry out various jobs, such as copy job, printer job, facsimile job and scan job, by performing processing in accordance with a prescribed program stored in the ROM.

Furthermore, in the ROM (an example of the setup item classification information memory means) mounted in the control unit 7, preliminarily memorized is setup item classification information indicating which each of various setup items associated with the Multi Function Peripheral is, an alternative setup item or an operation input setup item, which will be described hereinafter. Further, it differs depending on the model, specification, etc. of the Multi Function Peripheral which each of the setup items is, the alternative setup item or the operation input setup item. The setup item classification information will be referred as judgment indices in a copying processing to be hereinafter described (refer to FIG. 4).

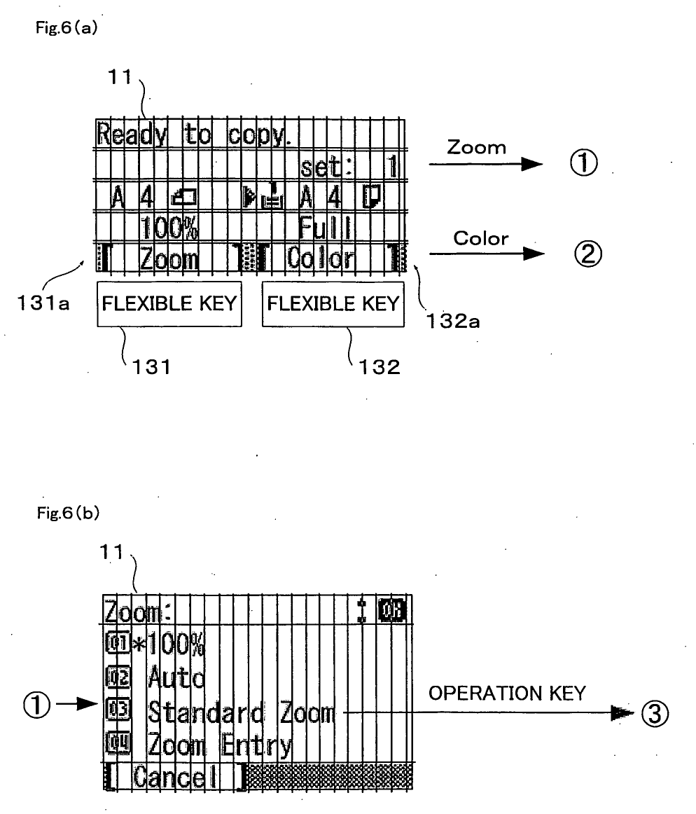

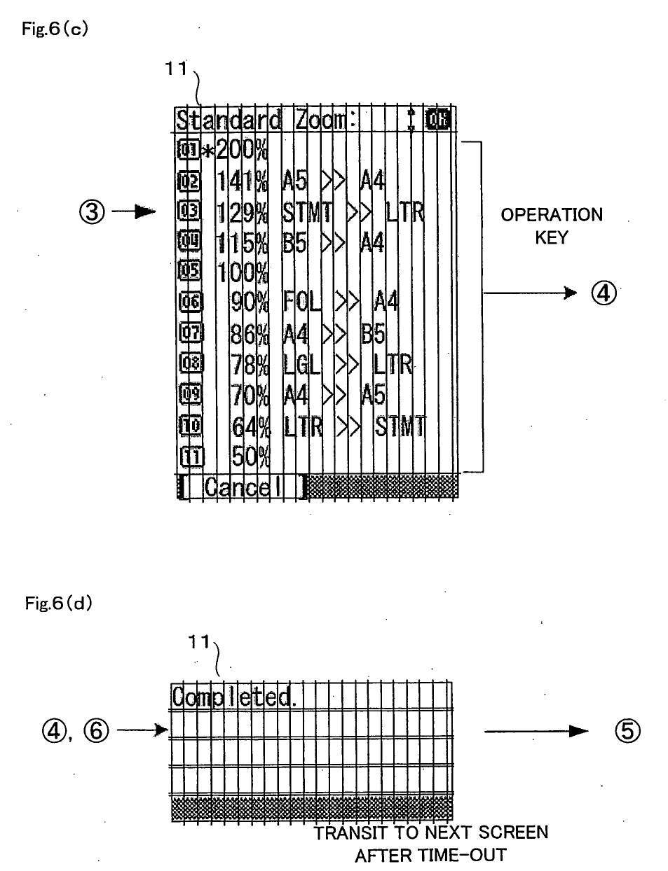

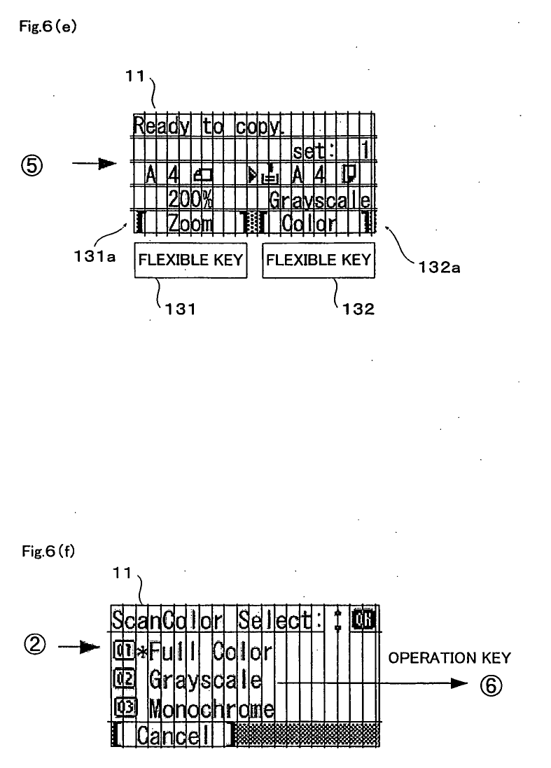

Now, the alternative setup item is a setup item to be set to one setup content selected from among a plurality of setup contents. For example, as explained with reference to FIG. 6 (f), when the color of image is set by choosing one of three choices of “Full color”, “Grayscale” and “Monochrome”, the color of image corresponds to the alternative setup item.

On the other hand, the operation input setup item is a setup item to be set to setup contents by operation inputting by using an operation key 12 to be hereinafter described. For example, as explained with reference to FIGS. 6 (b) and (c), if it is necessary to transit to a further lower layer of choice items or perform the input of numbers for setting magnification, the setting of magnification corresponds to the operation input setup item.

Next, the operation display unit 1 will be described with reference to the pattern diagram of FIG. 2.

As shown in FIG. 2, the operation display unit 1 is comprised of the liquid crystal display 11 for displaying various setup items associated with the Multi Function Peripheral (an example of the setup display means), the operation key 12 (an example of operation input keys) for operation inputting to set the various setup items, the flexible keys 131 and 132 (examples of shortcut keys), and the like. Here, the operation key 12, the flexible keys 131 and 132 correspond to the operation means. When the liquid crystal display 11 is provided with a touch panel, the operation key 12, the flexible keys 131 and 132, etc. are arranged as touch keys on the touch panel.

The operation key 12 is comprised of a numerical keypad 121 for inputting numbers and letters, a start key 122 for completing operation input by the numerical keypad 121, starting various jobs, etc., and the like. Moreover, the operation key 12 may be constructed to have an arrow key in stead of or in addition to the numerical keypad 121.

Meanwhile, when the flexible keys 131 and 132 are operated, the processing performed thereby differs respectively depending on the state of display on the liquid crystal display 11. The number of flexible keys is not limited to two of the flexible keys 131 and 132.

In the Multi Function Peripheral, according to initial setting or arbitrary setting by a user, any one of setup items concerning the Multi Function Peripheral is preliminarily assigned to the flexible keys 131 and 132 respectively. As a result, the user can easily set the setup items assigned to the flexible keys 131 and 132 by operating the flexible keys 131 and 132. More specifically, each of the flexible keys 131 and 132 is an example of shortcut key.

For example, when shortcut key registration processing is executed by the control unit 7 to cause the user to designate a setup item to be registered in the flexible keys 131 and 132 respectively, setup items are registered in the flexible keys 131 and 132 respectively. The control unit 7 for executing the shortcut key registration processing corresponds to the shortcut key registration processing means. Concerning the shortcut key registration processing, it would be possible to use the conventional method (e.g. refer to Japanese Patent Document 1) so that the details thereof will be omitted here.

In the present embodiment, the description will be given herein below with respect to the case where magnification (Zoom) is preliminarily assigned to the flexible key 131 and the color of image (Color) to the flexible key 132.

In this case, as shown in the pattern diagram of FIG. 3, it is indicated that the flexible key 131 corresponds to the setup item of magnification (Zoom as an example of operation input setup item) with the setup content of magnification thereof (100%) in the display area 131a above the flexible key 131 on the initial screen of the liquid crystal display 11 when a copy processing to be hereinafter described is executed (refer to FIG. 4). In the display area 132a above the flexible key 132, also indicated is that the flexible key 132 corresponds to the setup item of the color of image (Color as an example of alternative setup item) with the setup content of the color of image thereof (Full).

Next, an example of the procedure of copy processing executed by the control unit 7 in the Multi Function Peripheral will be described with reference to FIGS. 4 and 5. Here, S1, S2 . . . in FIG. 4 indicate procedure (step) numbers of copy processing. Furthermore. FIG. 5 shows the transition of display screens of the liquid crystal display 11 in the copy processing.

The copy processing starts at such a state that the initial screen is displayed in the liquid crystal display 11 as shown in FIG. 6 (a) when a copy job is selected by the user operating job selection keys although not shown.

As shown in FIG. 4, firstly, in the step S1, it is judged by the control unit 7 whether or not the operation of the start key 122 has been performed by the user. Here, if it is judged that the start key 122 has been operated (in a direction of Yes of S1), the control unit 7 starts coping at the setting status of the moment (S11). On the other hand, it is judged that the start key 122 hasn't been operated (in a direction of No of S1), the processing goes to the step S2.

In the step S2, it is judged by the control unit 7 whether or not either the flexible key 131 or 132 has been operated. Here, if it is judged that neither flexible key 131 nor 132 has been operated (in a direction of No of S2), the processing returns to the step S1. On the other hand, if it is judged either flexible key 131 or 132 has been operated (in a direction of Yes of S2), the processing goes to the step S3. The control unit 7 also executes processing for setting various setup items by using the operation key 12 in stead of using the flexible keys 131 and 132, but the description of the procedure will be omitted here.

In the step S3, it is judged by the control unit 7 whether or not a setup item assigned to the flexible key 131 or 132 judged to have been operated in the step S2 is the alternative setup item.

Specifically, the control unit 7 retrieves the setup item classification information memorized in the ROM of the control unit 7, and makes the above judgment based on the setup item classification information and the setup item assigned to the flexible key 131 or 132.

Then, if the setup item is judged to be the alternative setup item (in a direction of Yes of S3), the processing goes to the step S41, and if it is judged not to be the alternative setup item but judged to be the operation input setup item (in a direction of No of S3), the processing goes to the step S51. That is to say, the control unit 7 judges which the setup item is, the alternative setup item or the operation input setup item in the step S3.

Here, firstly, the description will be continued on the assumption that the flexible key 131 has been operated in the step S2. In this case, as the flexible key 131 is assigned to the setup item of magnification which is the operation input setup item, the control unit 7 causes the processing to go to the step S51 from the step S3.

In the step S51, the control unit 7 executes processing to cause the liquid crystal display 11 to display setup items in a layer below that of the setup item of magnification. As a result, a plurality of setup items is displayed in the liquid crystal display 11 as shown in FIG. 5 (b).

Then, in the step S52, it is judged by the control unit 7 whether or not an operation has been performed to select any one of setup items in the state of display shown in FIG. 5 (b). More specifically, the control unit 7 makes the above judgment based on operation input from the operation key 12. If it is judged that the operation to select a setup item has been performed (in a direction of Yes of S52), the processing goes to the step S53. By contraries, if the operation to select a setup item hasn't been performed (in a direction of No of S52), the processing for judgment in the step S52 is repeated.

In the step S53, the processing is executed by the control unit 7 to cause the liquid crystal display 11 to display a plurality of setup contents concerning the setup item selected in the step S52. This causes the liquid crystal display 11 to display a list of the plurality of setup contents as shown in FIG. 5(c).

Subsequently, in the step S54, it is judged by the control unit 7 whether or not an operation input has been performed to select any one of the plurality of setup contents displayed in the step S53 and complete the selection. More specifically, it is judged whether or not operation inputs for selection and completion have been performed by operating the numerical keypad 121 and the start key 122.

Here, if it is judged that the operation inputs have been performed (in a direction of Yes of S54), the processing goes to the step S55. If it is judged that the operation inputs haven't been performed (in a direction of No of S54), the processing for judgment in the step S54 is repeatedly executed until the operation inputs are performed.

Then, in the step S55, the setup content of magnification corresponding to the flexible key 131 is set by the control unit 7 to the setup content by operation input in the step S54. Here, the control unit 7 which performs such a processing corresponds to the setup processing means.

At this time, the liquid crystal display 11 displays the screen which shows that the setting has been completed as shown in FIG. 5 (d) and then the initial screen with the setup content of magnification which has been changed as shown in FIG. 5 (e). FIG. 5 (e) shows the result of setting when the operation input for setting magnification to 200% has been performed by the user.

In this way, in the Multi Function Peripheral, the operation input screens for operation inputting by using the operation key 12 are displayed when the flexible key 131 is operated, and the magnification assigned to the flexible 131 is set by operation inputting by using the operation key 12 by the user in accordance with the operation input screens (S51˜S55). Here, the control unit 7 which performs the processing for displaying the operation input screens corresponds to the operation display control means.

Next, the description will be given with respect to the case where it is judged that the flexible key 132 has been operated (in a direction of Yes of S2) in the step S2. In this instance, the flexible key 132 is assigned to the setup item of color of image which is the alternative setup item so that the control unit 7 causes the processing to go to the step S41 from the step S3.

In the step S41, only the setup content of color of image displayed in the display area 132a of the crystal liquid display 11 is switched to the next setup content by the control unit 7. More specifically, when the setup content of color of image displayed in the display area 132a shows full color (Full) as shown in FIG. 5 (a), the display is switched to monochrome (Monochrome) as shown in FIG. 5 (f) by the operation of the flexible key 132.

Then, in the step S42, the setup content of color of image is set to the new setup content displayed in the step S41 by the control unit 7, and the processing returns to the step S1. Now, the control unit 7 which performs such a processing corresponds to the setup processing means.

Subsequently, if the flexible key 132 is operated again in the step S2 (in a direction of Yes of S2), the display content in the display area 132a is changed to the next setup content in the step S41 same as before. More specifically, if the flexible key 132 is operated again in the state of FIG. 5 (f), grayscale (Grayscale) is displayed and set in the display area 132a as shown in FIG. 5 (e). If the flexible key 132 is operated one more time, the display content in the display area 132a returns to the initial display of full color (Full) as shown in FIG. 5 (a). The order of setup contents included in the alternative setup item is preliminarily set.

Thus, in the Multi Function Peripheral, when a setup item assigned to the flexible key 132 is the alternative setup item, in accordance with the operation of the flexible key 132 (every time when the operation is performed), a plurality of setup contents are switched (toggled) and displayed one by one in sequence in the display area 132a corresponding to the flexible key 132 on the liquid crystal display 11. Here, the control unit 7 which performs such a processing corresponds to the operation display control means.

Therefore, the user can easily set the color of image by operating only the flexible key 132 once or more times without operating the operation key 12.

As described hereinabove, in the Multi Function Peripheral, when the flexible keys 131 and 132 are operated, a setup approach is automatically switched to either of two approaches, with or without the operation key 12, depending on setup items assigned to the flexible keys 131 and 132. Therefore, when the setup items assigned to the flexible keys 131 and 132 are the alternative setup items, the user can easily set the setup item by simple operation without awareness of which is assigned to the flexible keys 131 and 132, the alternative setup item or the operation input setup item,

In this embodiment, the color of image is taken as an example of the alternative setup items and magnification is taken as an example of the operation input setup items. However, the alternative and operation input setup items are not limited to these.

For example, in copy processing, setup items set as the alternative setup items may include image quality setting (setup contents, such as “Text”, “Photo” and “Text+Photo”) and both side printing setting (setup contents, such as “ON” and “OFF”). Furthermore, in copy processing, setup items set as the operation input setup items may include setting for printing of multiple pages per sheet, arbitrary paper size, and arbitrary manuscript size.

In addition, in this embodiment, the copy processing executed in the Multi Function Peripheral (refer to FIG. 5) is taken as an example of job processing, but the same processing is executed for other jobs (such as facsimile job and scan job).

In a scan job, for example, the alternative setup items may include the color of image (setup contents, such as “Full Color”, “Monochrome” and “Grayscale”), resolution (setup contents, such as 200×100, 200×200, 300×300, 400×400 and 600×600), file format (setup contents, such as PDF, TIFF and XPS), and the like. Furthermore, the operation input setup items may include arbitrary reading size, arbitrary output size, and the like.

In a similar way, in a facsimile job, the alternative setup items may include the color of image (setup contents, such as “Full Color”, “Monochrome”, and “Grayscale”), resolution (setup contents, such as 200×100, 200×200, 300×300, 400×400 and 600×600), and the like. Furthermore, the operation input setup items may include arbitrary reading size, arbitrary output size, send time setting, and the like.

In the copy processing, setup items such as magnification and the color of image are assigned to the flexible keys 131 and 132 respectively. As another embodiment, however, it would be possible to set setup items to be assigned to the flexible keys 131 and 132 respectively by job classification.

What is claimed is:

1. An image processing apparatus, comprising:
a setup display means for displaying various setup items concerning the image processing apparatus;
an operation means having operation input keys for operation inputting to set the various setup items, and one or more shortcut keys;
a shortcut key registration processing means for assigning any one of the setup items to the shortcut key or each of the shortcut keys, wherein
the image processing apparatus further comprises:
an operation display control means for displaying a plurality of setup contents one by one in sequence in a display area(s) of an alternative setup item(s) displayed in the setup display means according to the operation of the shortcut key(s) when the setup item(s) assigned to the shortcut key(s) by the shortcut key registration processing means is/are the alternative setup item(s) set to one setup content selected from the plurality of setup contents, and for displaying an operation input screen for operation inputting by using the operation input keys according to the operation of the shortcut key(s) when the setup item(s) is/are an operation input setup item(s) set to setup contents by operation inputting by using the operation input keys; and
a setup processing means which sets the setup item(s) to setup contents which are displayed by the operation display control means or to setup contents which are input by using the operation input keys in accordance with the operation input screen displayed by the operation display control means.

2. The image processing apparatus according to claim 1, wherein further comprises a setup item classification information memory means for memorizing setup item classification information indicating which each of the various setup items is, the alternative setup item or the operation input setup item; and
the operation display control means judges which the setup item(s) assigned to the shortcut key(s) is/are, the alternative setup item(s) or the operation input setup item(s) based on the setup item classification information memorized in the setup item classification information memory means.

3. The image processing apparatus according to claim 1, wherein the alternative setup item(s) and the operation input setup item(s) are displayed in the initial screen of the setup display means; and
when the initial screen is displayed in the setup display means, the operation display control means switches only setup contents from one to another in the display area(s) of the alternative setup item(s) every and each time of the operation of the shortcut key(s) corresponding to the alternative setup item(s), and changes the initial screen to the operation input screen when the shortcut key(s) corresponding to the operation input setup item(s) is/are operated.

4. The image processing apparatus according to claim 2, wherein the alternative setup item(s) and the operation input setup item(s) are displayed in the initial screen of the setup display means; and
when the initial screen is displayed in the setup display means, the operation display control means switches only setup contents from one to another displayed in the display area(s) of the alternative setup item(s) every and each time of the operation of the shortcut key(s) corresponding to the alternative setup item(s), and changes the initial screen to the operation input screen when the shortcut key(s) corresponding to the operation input setup item(s) is/are operated.

5. The image processing apparatus according to claim 1 wherein further comprising a scanner unit for reading image data on a sheet of manuscript and an image forming unit for forming images based on the image data.

6. The image processing apparatus according to claim 2 wherein further comprising a scanner unit for reading image data on a sheet of manuscript and an image forming unit for forming images based on the image data.

7. The image processing apparatus according to claim 3 wherein further comprising a scanner unit for reading image data on a sheet of manuscript and an image forming unit for forming images based on the image data.

8. The image processing apparatus according to claim 4 wherein further comprising a scanner unit for reading image data on a sheet of manuscript and an image forming unit for forming images based on the image data.

9. The image processing apparatus according to claim 1 wherein further comprising a facsimile communication unit for transmitting and receiving image data.

10. The image processing apparatus according to claim 2 wherein further comprising a facsimile communication unit for transmitting and receiving image data.

11. The image processing apparatus according to claim 3 wherein further comprising a facsimile communication unit for transmitting and receiving image data.

12. The image processing apparatus according to claim 4 wherein further comprising a facsimile communication unit for transmitting and receiving image data.
